(19) United States
(12) Patent Application Publication
(10) Pub. No.: US 2004/0125453 A1
(43) Pub. Date: Jul. 1, 2004

(54) Inverse computation of phase masks for two layer diffractive optic element system

(76) Inventor: Alastair D. McAulay, Allentown, PA (US)

Correspondence Address: Eastman & Associates, Suite 1800, 707 Broadway Street, San Diego, CA, 92101, US

(21) Appl. No.: 10/613,738

(22) Filed: Jul. 3, 2003

Related U.S. Application Data
(60) Provisional application No. 60/393,927, filed on Jul. 3, 2002.

(51) Int. Cl. G02B 5/18; G02B 27/44

(52) U.S. Cl. 359/566

(57) ABSTRACT

A two layer system can transform an arbitrary specified light field at an input plane to a desired light field at an output plane. The light field includes both intensity and phase. Such a system can be cascaded for higher level functionality. There are two computations involved. The first computes a sensitivity matrix symbolically. The elements of the matrix hold the variation in each element at the output plane with variation in each element of both phase screens. An element of this matrix is provided for reference. The second algorithm iteratively updates the phase screen values to bring the output field to that desired. On each iteration, the algorithm performs a forward computation from input to output. The phase values are updated using the sensitivity matrix and the error at the output relative to that desired.

### CROSS REFERENCE TO RELATED APPLICATIONS

This application claims the benefit of priority from Provisional Patent Application Serial No. 60/393,927 filed Jul. 3, 2002 entitled “Inverse Computation of Phase Masks for Two Layer Diffractive Optic Element” and currently co-pending.

### BACKGROUND OF THE INVENTION

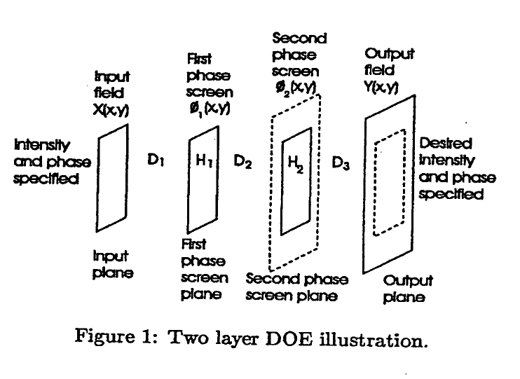

Two layer diffractive optic element (DOE) or hologram systems, shown in FIG. 1, are of interest because they allow a specified light field in an input plane to be redirected into a desired light field at an output plane. The light field has both intensity and phase at every point in the plane transverse to the direction of propagation. This allows such units to be cascaded and hence capable of being used as building blocks for more complicated structures. Further, changing the propagation model from free space to waveguide allows the same approach for designing holographic elements to control light in multiple sequence photonic integrated circuits, PICs, or for use in interconnecting SOAs for arbitrary high speed logic [4]. Two sequential phase screens may also be used for free space interconnection logic [7] (Ch. 9).

Section 2 discusses a widely used approach for synthesizing a single phase screen for comparison and then describes the two layer synthesis problem. Section 3 provides a summary of the proposed algorithm for computing phase screens in two layer systems, both forward and inverse computations. Section 4 and 5 provide details of the forward propagation computation and the inverse computation respectively. A conclusion is presented in section 6.

### 2. Current and Proposed Approaches

Most current approaches to synthesizing holograms or DOEs cannot produce cascadable units. One such single DOE algorithms is described for the purpose of illustration in section 2.1. The problem for the two layer DOE is described in section 2.2.

2.1. Phase-only Single DOE Synthesis Approach.

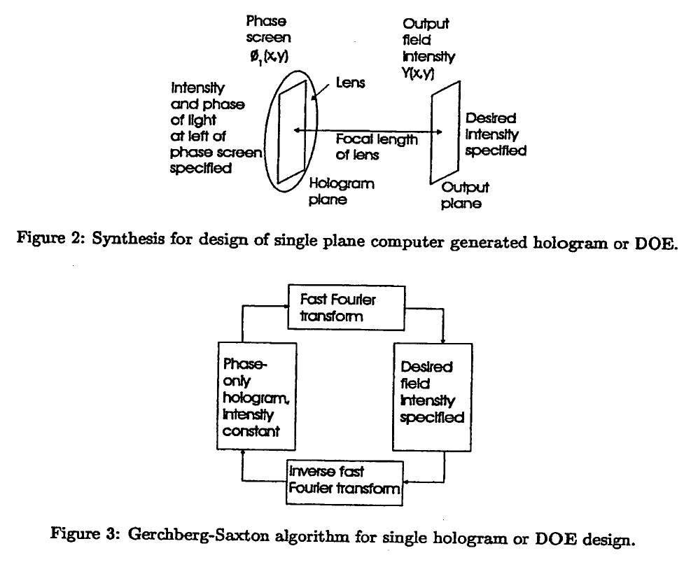

A number of numerical methods have been developed for synthesizing a single hologram or diffractive optic element (DOE) such that light entering a diffractive optic element is directed into an output plane with a desired intensity [11] as shown in FIG. 2. To minimize loss of light in passing though the hologram, the latter is often restricted to phase only. A lens is used to focus light to the output plane placed at the focal point of the lens. This allows propagation to be modeled by a Fourier transform.

A typical widely used algorithm is this case is that by Gerchberg and Saxton [1] as shown in FIG. 3. A plane wave entering the DOE is assumed. The propagation between DOE and output plane is modeled by taking a Fourier transform (FT) of the DOE output. At the output plane, the intensity is changed to that desired at the output plane. The phase is left at whatever value it has, as there is no requirement on output plane phase. An inverse Fourier transform (IFT) is used to transform the signal back to the DOE plane. At this point the intensity is set to one as we desire only a phase variation. Repeated iterations of this loop will generate the optimum phase DOE to produce the required output intensity at the output plane. As only intensity is specified at the output plane, such a system cannot be cascaded.

A generalization of this system excludes the lens, allowing the lens function to be performed by the hologram, and replaces the Fourier transform by a Fesnel diffraction formula. This allows the distance between hologram and output plane to be varied within the Fresnel diffraction zone, normally from millimeters to several meters.

2.2 Two Layer DOE Synthesis Problem

Here we examine the system shown in FIG. 1. We assume light of specified intensity and phase at an input plane that diffracts into the two layer system. Because of the similarity with layered models used for the propagation of light through turbulence [6] [5], we use the name phase screen for the phase-only DOE or phase-only hologram. In the case of turbulence, the effects of turbulence are localized in the phase screens and light is propagated between phase screens as though turbulence was absent. In our case, the light also propagates through free space between planes. The light propagates form the input plane to the first phase screen. It then passes through the first phase screen and propagates to the second phase screen. It passes through the second phase screen and propagates to the output plane. The phase screen phase values are computed to produce a specified intensity and phase at the system output plane, given a specified intensity and phase field at the system input plane.

In FIG. 1, we also show a way to computationally cope with the diffraction spreading into larger transverse areas. The second phase screen is padded around with zeroes on all sides so as to transform to a larger area output.

### 3. Summary of Algorithm for Computing Phase Screens in Two Layer System

3.1. Forward Computation

All operators and fields are assume to be functions of orthogonal directions x and y transverse to the direction of propagation z. Light fields are assumed to have both intensity and phase defined at every x-y elements in the field. While transverse fields are continuous, we will descretize them for the purpose of computation, with sufficient resolution to maintain the highest spatial frequencies desired. The following is a summary, the individual items are elaborated subsequently.

Propagation of the light field from one plane to another is described by the operator D. The spatially discretized form of D will be a matrix. Propagation through a phase screen is accomplished by modifying each element of the incoming light by adjustment of phase φ. If the incoming 2-D plane of light is rearranged as a vector, element by element multiplication for the phase screen can be represented by multiplication by a diagonal matrix H with elements H_{n,m}=exp{jφ_{n,m}}. As we plan to determine the optimum H for each phase screen, we use small random values for the first iteration or an educated guess and then iterate to improve the values so as to meet the required output field. Further, we use a subscript to indicate which phase screen or region is in consideration starting with 1 at the left in FIG. 1. Therefore, for the ith iteration and the jth phase screen in the layered model we write Hⱼ(i). The forward computation from input plane to output plane at the ith iteration can then be represented by:

F(i)=D₃H₂(I)D₂H₁(I)D₁ (1)

Given an input field X, the field in the output plane can be written:

Y(I)=D₃H₂(I)D₂H₁(I)D₁X (2)

For convenience in subsequent steps the two phase screens are included as partitions into a single matrix:

φ(i)=[φ₁i|φ₂(i)] (3)

As an example, used for computing the sensitivity element shown in the appendix, for two 1-D four long phase screens the phase values can be written:

φ(i)=[p11 p12 p12 p14 |p21 p22 p23 p24 ] (4)

Note that, FIG. 1, as the output is twice the size of the phase screens, there are the same number of unknown phase terms in the equations as there are terms in the output plane.

3.2. Inverse Computation

A square sensitivity matrix S(i) is computed using:

See Equation 5 in Table of Equations (5)

The output field at this point will differ from the desired output field Y_{d}. Therefore we compute difference vector ΔY (i) for every element in the 2-D plane.

ΔY(i)=Y(i)−Y_{d} (6)

The phase screen values for the ith iteration are substituted into the sensitivity matrix and the incremental update for the phase screens Δφ is obtained by solving the equation:

S(i)Δφ(i)=ΔY(i) (7)

For realistic size problems the ill condition of S(i) must be taken into account in finding an acceptable solution. The phase screens are now updated for the next iteration:

φ(i+1)=φ(i)+Δφ(i) (8)

We now return to equation (2) with i+1 in equation (6) replaced by i to perform the next iteration. We stop iterating when the normalized changes are sufficiently small, for example:

See Equation 9 in Table of Equations (9)

We stop iterating if the error no longer decreases noticeably from one iteration to the next. In this case we may need to change the phase screen size or sampling to come closer to the desired accuracy.

### 4. Details of Forward Computation for Computing Phase Screens in a Two Layer System

4.1. Details of Propagation in Free Space Between Planes

The propagation distance between planes, z, is chosen constant for conveniences and is assumed much greater than the maximum dimensions transversely in x and y. In this case the Helmholtz wave equations can be approximated by the paraxial wave equation:

See Equation 10 in Table of Equations (10)

Propagation from one plane to another across the layer, across z, can be accomplished by using the Huygens-Fresnel principle [2]. This Frensel diffraction can be written as a convolution integral for homogeneous media:

U(x,y)=∫∫U(ξ,\acute{η})h(x−ξ,y−eta)dξ\acute{η} (11)

Where the impulse response is:

See Equation 12 in Table of Equations (12)

The transfer function is the Fourier transform of the impulse response [2]:

See Equation 13 in Table of Equations (13)

Note that convolution in the space domain becomes multiplication in the Fourier transform domain. Therefore propagation of a field U through a distance Δz is achieved by taking its Fourier transform, multiplying by the transform function in equation (13) and then taking the inverse Fourier transform:

U(x,y,z+Δz)=F⁻¹{FU(x,y,z)H(kₓ,K_{y})} (14)

4.2. Details of Propagation Through a Phase Screen

In propagating through a phase screen, each element of the field in the transverse x-y plane is multiplied by exp{φ(i)}. If the 2-D transverse field is written as a vector, the operation can be written as multiplication by a diagonal matrix. For example a 2×2 phase screen φ(n,m) gives a matrix:

See Equation 15 in Table of Equations (15)

where the diagonal elements are the transverse values exp{φ_{n,m}(i)} at the transverse x-y coordinate for the phase screen at the ith iteration.

### 5. Details of Computation of the Sensitivity Matrix and Inverse Computation

5.1 Symbolic Propagation Through a Phase Screen with Phase Values as Variables

In order to compute a sensitivity matrix we perform a symbolic discrete Fourier transform for propagation through free space instead of a Fast Fourier transform as used in section 2.1. For example, a 1-D discrete Fourier transform from u to U for vectors of length N=4 can be written as a matrix-vector multiplication:

See Matrix 16 in Table of Equations (16)

where dx=λ/10 is the interval between samples in the space domain, λ is the wavelength of the light and

W=exp(2*πj/N) (17)

Similarly, the 1-D discrete inverse Fourier transform from U to u can be written as a matrix-vector multiplication:

See Matrix 18 in Table of Equations (18)

where dfx is the interval between samples in the spatial frequency domain. Note that dx*dfx=1/N. Matrix multiplication of equation (16) by equation (18) gives the identity matrix, consistent with forward and inverse transformations canceling each other out. Note that the Fourier transform and inverse Fourier transform per-formed for D₃ has twice the dimension of that for D₁ and D₂ as explained previously. For 2-D phase screens we need to use 2-D Fourier transforms.

5.3. Inverse Computation to Estimated Phase Values in Screens

Equations (7) is a nonlinear equation for the phase value corrections because the sensitivity matrix depends on the iteration and current phase. It is solved by linearization in the iteration method proposed. For large realistic matrices, Gauss elimination and similar methods take too long. The most practical technique for solving such large equation sets, where ill-conditioning is normally an issue, is the conjugate gradient method [3] [8]. Solution time depends on the clustering of eigenvalues in the sensitivity matrix after the current phase values have been inserted. Further it is normal to condition the matrix, first by normalizing rows and backing out the normalization at a later time and second by preconditioning the matrix to improve the eigenstructure. The precondition must also be backed out later. The conjugate gradient method will provide the minimum energy solution which will normally be perfectly adequate to achieve the goal of correctly directing the intensity and phase of the light into the output plane. It is not required that a unique solution be found, rather any that adequately performs the necessary function will suffice. We are currently validating the approach for design of two layer phase screen systems and have not yet adequately verified the results to warrant inclusion.

### CONCLUSION

We proposed a method of designing phase screens, also known as phase-only holograms or diffractice optical elements, when two such screens are used in sequence to change a specified light field at an input plane to a desired light field at an output plane. In this case the intensity and phase at the input plane and the desired intensity and phase at the output plane are fully specified. The method allows the output plane to be larger than the input plane for diffraction spreading. Such units can be cascaded to create more complex structures, unlike the case for a single hologram or DOE.

The method involves a symbolic and a numeric computation. In the symbolic computation, the forward computation of the field from input to output is performed using discrete Fourier transforms and leaving phase elements in the phase screens as variables. A sensitivity matrix is computed by differentiation of the output with respect to the phase variables. Matrix elements represent the change in output elements with respect to change in phase value. The symbolic first element of the matrix is recorded for reference. The numerical computation performs the following operations iteratively until the output field adequately represents the desired field. With the current values for the phase, the forward computation is computed to obtain an output field. The difference between this field and the desired field is used with the sensitivity matrix to compute an update to the phase values. The algorithm presented is very computationally demanding and is practical only because of the increased performance of computers and the improved developments in handling large matrix ill-conditioned equations. Note that a unique solution is not required, only one that accomplishes the goal of converting light in the input plane to the desired field at the output plane.

In addition to verifying the algorithm for specific cases, an important extension is possible. Replacing the free space propagation with waveguide propagation allows the design of cascadable logic as in a photonic integrated circuit (PIC).

### Appendix A

The first element of an 8×8 sensitivity matrix, for two four long 1-D phase screens, is shown for illustrative purposes and to provide a reference for anyone else attempting this approach. p11, p12, p13, p14, p21, p22, p23, p24 represent the phase elements for the two phase screens.

element 11:−evalf(sens2[1,1],3);element11:=

(−0.418e6−0.721e6*I)*((0.883e−8−0.612e−7*I)*p21−(0.265e−7+0.306e−7*I)*p22+(0.265e−7+0.306e−7*I)*p23−(0.265e−7+0.306e−7*I)*p24)+(0.833e6−753.*I)*((−0.612e−7−0.883e−8*I)*p21+(−0.290e−8+0.404e−7*I)*p22−(0.265e−7+0.306e−7*I)*p23+(0.404e−7+0.290e−8*I)*p24)−(0.417e6+0.722e6*I)*((−0.883e−8+0.612e−7*I)*p21+(0.306e−7−0.265e−7*I)*p22+(0.265e−7+0.306e−7*I)*p23+(−0.306−7+0.265e−7*I)*p24)−(0.417e6+0.722e6*I)*((0.612e−7+0.883e−8*I)*p21−(0.404e−7+0.290e−8*I)*p22−(0.265e−7+0.306e−7*I)*p23+(0.290e−8−0.404e−7*I)*p24)+(0.833e6+0.*I)*((0.883e−8−0.612e−7*I)*p21+(0.265e−7+0.306e−7*I)*p22+(0.265e−7+0.306e−7*I)*per+(0.265e−7+0.306e−7*I)*p24)−(0.417e6+0.722e6*I)*((−0.612e−7−0.883e−8*I)*p21+(0.290e−8−0.404e−7*I)*p22−(0.265e−7+0.306e−7*I) *p23−(0.404e−7+0.290e−8*I)*p24)−(0.417e6+0.722e6*I)*((−0.883e−8+0.612e−7*I)*p21+(−0.306e−7+0.265e−7*I)*p22+(0.265e−7+0.306e−7*I)*p23+(0.306e−7−0.265e−7*I)*p24)+(0.833e6−753.*I)*((0.612e−7+0.883e−8*I)*p21+(0.404e−7+0.290e−8*I)*p22−(0.265e−7+0.306e−7*I)*p23+(−0.290e−8+0.404e−7*I)*p24)

### 6. References

1. R. W. Gerchberg and W. O. Saxton, “A practical algorithm for the determination of the phase from image and diffraction plane pictures,” Optik, 35(2),pp.237-246, 1972.

2. J. W. Goodman, Introduction to Fourier Optics, 2^{nd} Edn., McGraw-Hill, New York, 1996.

3. M. Hestenes, Conjugate direction methods in optimization, Springer-Verlag, New York, 1980.

4. A. D. McAulay, “All optical logic gates using semiconductor optical amplifiers,” 4788-11, SPIE Photonic devices and algorithms for computing IV, July 2002.

5. A. D. McAulay, “Artificial turbulence generation alternatives for use in computer and laboratory experiments,” SPIE High Resolution wavefront control, method, devices and applications III, Aug. 2001

6. A. D. McAulay, “Generating Kolmogorov phase screens for modeling optical turbulence,” SPIE Laser Weapons Technology Conference, 4034-07, April 2000

7. A. D. McAulay, Optical Computer Architectures. Wiley (1991).

8. A. D. McAulay,“Conjugate Gradients on Optical Crossbar Interconnected Multiprocessor,” Journal of Parallel and Distributed Processing, 6:136-150, Feb 1989.

9. A. D. McAulay, “Plane-Layer Prestack Inversion in the Presence of Surface Reverberation,” Geophysics, 51(9):1789-1800, 1986.

10. A. D. McAulay, “Prestack Inversion with Plane-Layer Point Source Modeling,” Geophysics, (50^{th} Anniversary Volume), 50(1):77-89, Jan. 1985.

11. V. A. Doifer, Methods for computer design of diffrative optical elements, Wiley, New York, 2002.

What is claimed is:

1. A method of optimizing phase masking in a diffractive optic element system, comprising:
a diffractive optic element having a first layer and a second layer, wherein said first layer is formed with a phase mask at a first angle, and said second layer is formed with a phase mask at a second angle;
exposing said diffractive optic element to a light source;
computing the diffraction of said light source spreading from said second layer; and
analyzing said computed diffraction from said second layer and comparing said computed diffraction to a predetermined error value.
